(19) United States
(12) Patent Application Publication
(10) Pub. No.: US 2017/0169483 A1
(43) Pub. Date: Jun. 15, 2017

(54) METHOD FOR PUSHING AND DISPLAYING INFORMATION AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Yang SHEN, Beijing (CN); Weibo AO, Beijing (CN)

(21) Appl. No.: 15/242,273

(22) Filed: Aug. 19, 2016

Related U.S. Application Data
(63) Continuation of application No. PCT/CN2016/089262, filed on Jul. 7, 2016.

(30) Foreign Application Priority Data
Dec. 11, 2015 (CN) 201510919724.0

(51) Int. Cl. G06Q 30/02; H04L 29/06; H04L 29/08

(52) U.S. Cl. CPC G06Q 30/0277; H04L 67/26; H04L 67/42

(57) ABSTRACT

The present disclosure discloses a method for pushing and displaying information and electronic device thereof. In the solution, an information request is transmitted by a terminal to an information server; information data including primary information data and standby information data is pushed by the information sever to the terminal when the information sever receives the information request transmitted from the terminal; when the terminal receives the information data, information is displayed with the standby information data by the terminal if determining the primary information data as invalid information data.

### CROSS-REFERENCE TO RELATED APPLICATIONS

The present application is a continuation of international application No. PCT/CN2016/089262 filed on Jul. 7, 2016, which is based upon and claims priority to Chinese Patent Application No. 201510919724.0, filed on Dec. 11, 2015, which is incorporated herein by reference in its entirety.

### TECHNICAL FIELD

The present disclosure relates to the technical field of information pushing, and in particular, to a method for pushing and displaying information and electronic device thereof.

### BACKGROUND

With the development of technology, various types of terminals emerge in people's work and daily life, such as computer, vehicle terminal, smart phone and the like. In applications, sometimes terminals may obtain and display information pushed by information servers. For example, when users play video using terminals, the terminals may obtain advertising data pushed by advertising servers to play advertisements, thereafter playing video for users.

Referring to the structural diagram as shown in FIG. 1, generally, terminal 1 is connected to a plurality of information servers 2. Currently, if the terminal 1 needs to acquire information being pushed, it may generate an information request and transmit the information request to the information servers 2; when receiving the information request, the information servers 2 may push information data to the terminal 1; according to the obtained information data, the terminal 1 may display corresponding information, so that information can be displayed.

However, the inventor found in the study of the present disclosure that, in the prior art, sometimes, information data that an information server pushes is invalid information data, which causes the terminal unable to display information pushed by the information server. For example, if advertising data pushed by an advertising server is incomplete, namely, the advertising data is invalid information data, the terminal is unable to play advertisements according to the advertising data.

### SUMMARY

The present disclosure provides a method for pushing and displaying information and electronic device thereof, to solve, in some degree, problem in conventional techniques that a terminal is unable to display information when receiving invalid information data.

To solve the above technical problem, embodiments of the present disclosure disclose the following technical solutions.

According to a first aspect of embodiments of the present disclosure, a method for pushing information is provided, including:

receiving, by an information server, an information request transmitted from a terminal; and

pushing, by the information server, information data to the terminal, the information data including primary information data and standby information data so as to allow the terminal to display information with the standby information data when the terminal determines the primary information data as invalid information data.

According to a second aspect of embodiments of the present disclosure, a method for displaying information is provided, including:

transmitting, by a terminal, an information request to an information server so as to allow the information server to push information data to the terminal when the information sever receives the information request;

receiving, by the terminal, the information data pushed by the information server, the information data including primary information data and standby information data; and

invoking, by the terminal, the standby information data to display information when the terminal determines the primary information data as invalid information data.

According to a third aspect of embodiments of the present disclosure, there provides a non-volatile computer readable storage medium stored with computer executable instructions, which are set to perform any one of the methods for pushing information of the present disclosure as described above.

According to a fourth aspect of embodiments of the present disclosure, there provides another non-volatile computer readable storage medium stored with computer executable instructions, which are set to perform any one of the methods for displaying information of the present disclosure as described above.

According to a fifth aspect of embodiments of the present disclosure, there provides an electronic device including one or more processors and a memory, wherein the memory is stored with instructions executable by the one or more processors, and the instructions are set to perform any one of the methods for pushing information of the present disclosure as described above.

According to a sixth aspect of embodiments of the present disclosure, there provides an electronic device including one or more processors and a memory, wherein the memory is stored with instructions executable by the one or more processors, and the instructions are set to perform any one of the methods for displaying information of the present disclosure as described above.

It should be understood that, the above general description and the detailed description hereinafter are merely exemplary and explanatory, which are not to limit the scope of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the technical solutions of the embodiments of the present disclosure or of the prior art, the drawings needed in the description of the embodiments or the prior art will be briefly introduced below. Apparently, the figures in the description below are some embodiments of the present disclosure, and other drawings may also be obtained by one of ordinary skill in the art according to these drawings without creative work.

FIG. 1 schematically illustrates connections between a terminal and information servers;

FIG. 2 schematically illustrates a flowchart of a method for pushing information according to an embodiment of the present disclosure;

FIG. 3 schematically illustrates a flowchart of a method for displaying information according to an embodiment of the present disclosure;

FIG. 4 schematically illustrates a flowchart of displaying information with standby information data in the method for displaying information according to an embodiment of the present disclosure;

FIG. 5 is a structural diagram schematically illustrating an electronic device for pushing information according to an embodiment of the present disclosure;

FIG. 6 is a structural diagram schematically illustrating an electronic device for displaying information according to an embodiment of the present disclosure;

FIG. 7 is a schematic structure diagram of a device for performing a method for pushing information according to an embodiment of the present disclosure; and

FIG. 8 is a schematic structure diagram of a device for performing a method for displaying information according to an embodiment of present disclosure.

### DETAILED DESCRIPTION

Embodiments of the present disclosure provide a method for pushing and displaying information and device thereof to solve, to some degree, the problem in conventional techniques that a terminal is unable to display information when receiving invalid information data.

In order to allow a person skilled in the art to understand technical solutions of the embodiments of the present disclosure better, and in order to make the above objects, features and advantages of the embodiments of the present disclosure more apparent, the technical solutions in the embodiments of the present disclosure will be further described in detail below in conjunction with the drawings.

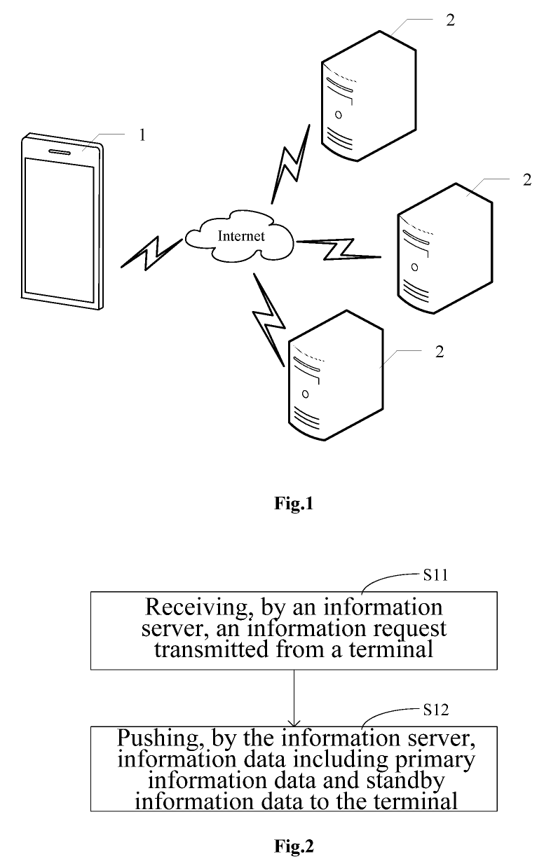

In an exemplary embodiment of the present disclosure, a method for pushing information is provided. Referring to the flowchart of FIG. 2, the method for pushing information may include the following steps.

In step S11, an information request transmitted from a terminal is received by an information server.

When a terminal is required to display information, an information request may be transmitted to an information server, so as to allow the information server to push information data to the terminal. For example, if a terminal is required to play advertisements, an advertising request may be transmitted to an advertising server, so as to allow the advertising server to push advertising data to the terminal. The advertising server belongs to one type of information servers.

In step S12, information data including primary information data and standby information data is pushed by the information server to the terminal, so as to allow the terminal to display information with the standby information data when the terminal determines the primary information data as invalid information data.

The information data may usually be address link, such as URL (Uniform Resource Locator) address for the information. For example, if the information data is advertising data, the advertising data is address link of advertisement. Of course, the information data may also be data in other forms, which is not limited to the above.

When receiving the information request transmitted by the terminal, the information server may push information data to the terminal. Upon receiving the information data, the terminal may analyze it. If primary information data included in the information data is valid information, information may be displayed with the primary information data; if primary information data included in the information data is invalid information, it may be replaced with standby information data to display the information.

The present disclosure discloses a method for pushing information. In this method, an information server may push information data including primary information data and standby information data to a terminal when receiving the information request transmitted from the terminal; when receiving the information data, the terminal may display information with the standby information data if the primary information data is determined as invalid information data. Compared with the prior art, the present disclosure can display information using standby information data when invalid information data is obtained, thereby solving the problem in the related art that a terminal is unable to display information when receiving invalid information data.

Further, the information data pushed by the information server may be provided with priority tags, and the primary information data has a higher priority than that of the standby information data.

If information data is provided with priority tags, the terminal may analyze priority tag corresponding to each of information data when receiving the information data pushed by the information sever, and determine information data with higher priority as primary information data and information data with lower priority as standby information data, thereby distinguishing primary information data from standby information data using priority tags.

Moreover, the information data may also be arranged in a preset sequence. For example, in information data pushed by each of information servers, primary information data may be arranged before standby information data. However, an information server may push three primary information data, in which case, the terminal, when receiving the information data pushed by the information sever, may determine the first three information data thereof as primary information data while other information data as standby information data, in such a way that the terminal may distinguish primary information data from standby information data according to the arranged sequence of information data.

In the present disclosure, the information server may be in various forms. For example, the information server may be an advertising server, and then information data may be advertising data. Usually, a terminal is connected to one or more advertising servers. If an advertisement is required to be played, the terminal may send an advertising request to an advertising server. When the advertising request is received, the advertising server may push advertising data, which includes primary advertising data and standby advertising data, to the terminal by using the method for pushing information according to the present disclosure. Upon receiving the advertising data: if the primary advertising data thereof is determined to be valid, the terminal may play advertisement corresponding to the primary advertising data; if the primary advertising data is invalid, the terminal may play advertisement corresponding to the standby advertising data. Thus, the problem that a terminal is unable to play advertisement when receiving invalid advertising data can be avoided.

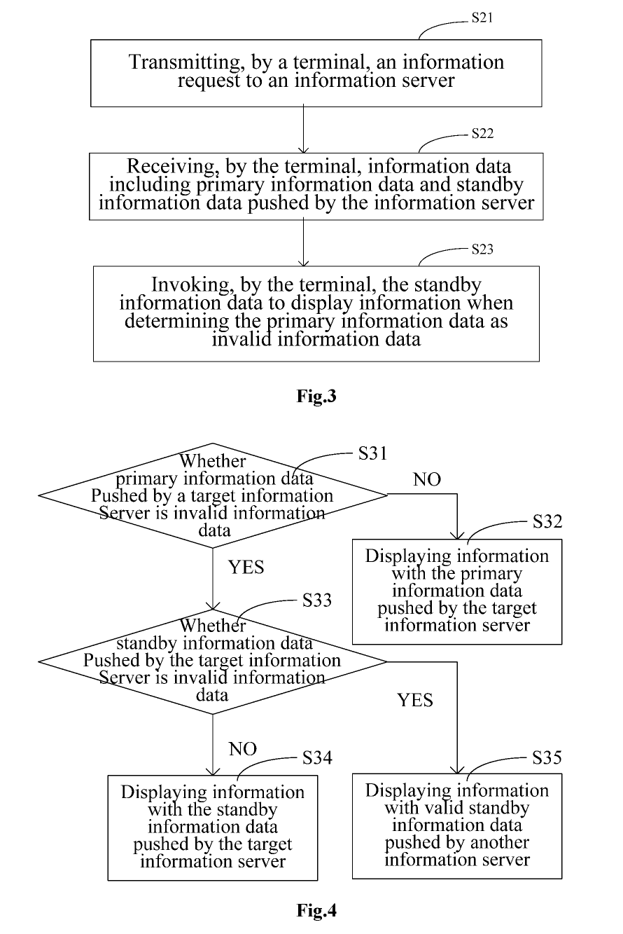

Accordingly, a second embodiment of the present disclosure discloses a method for displaying information. Referring to the flowchart of FIG. 3, the method for displaying information may include the following steps.

In step S21, an information request is transmitted to an information server by a terminal so as to allow the information server to push information data to the terminal when the information sever receives the information request.

In step S22, the information data pushed by the information server is received by the terminal, the information data including primary information data and standby information data.

In step S23, the standby information data is invoked by the terminal to display information when the terminal determines the primary information data as invalid information data.

When receiving information data pushed by the information server, the terminal may analyze the information data and determine whether each of the information data is valid. if information data pushed by an information server is null or incomplete, the information data may be determined as invalid information data; additionally, if the displaying mode corresponding to the information data is not supported by the terminal, generally, the terminal may also determine the information data to be invalid information data.

The present disclosure discloses a method for displaying information. In this method, a terminal may transmit an information request to each of information servers; the information server may push information data including primary information data and standby information data to the terminal when receiving the information request transmitted from the terminal; upon receiving the information data, the terminal may display information with the standby information data if the primary information data is determined to be invalid information data. Compared with the related art, the present disclosure can display information using standby information data when invalid information data is obtained, thereby solving the problem in the related art that a terminal is unable to display information when receiving invalid information data.

Information data pushed by the information server may be generally provided with priority tags, and the primary information data may have a higher priority than that of the standby information data. The terminal may analyze priority tag corresponding to each of information data when receiving the information data pushed by the information sever, and determine information data with higher priority as primary information data and information data with lower priority as standby information data, thereby distinguishing primary information data from standby information data using priority tags.

Moreover, information data pushed by the information server may also be arranged in a preset sequence. For example, in the information data pushed by each information server, primary information data may be arranged before standby information data. However, an information server may push three primary information data, in which case, the terminal, when receiving the information data pushed by the information sever, may determine the first three information data thereof as primary information data while other information data as standby information data, thereby distinguishing primary information data from standby information data.

Step S23 of the present disclosure discloses that the standby information data is invoked by the terminal to display information when the terminal determines the primary information data as invalid information data. The step may be implemented in various ways.

In one of the ways, referring to the flowchart of FIG. 4, the standby information data may be invoked by the terminal to display information when the terminal determines the primary information data as invalid information data, which includes the following steps.

In step S31, primary information data pushed by a target information server is analyzed by the terminal, and according to the analysis results, whether the primary information data pushed by the target information server is invalid information data is determined by the terminal. If not, the operation of step S32 is performed; if so, the operation of step S33 is performed.

The target information server may be any one of servers that may push information data to the terminal.

In step S32, if the primary information data pushed by the target information server is determined, according to the analysis results, to be not invalid information data, information is displayed using the primary information data pushed by the target information server.

In step S33, if the primary information data pushed by the target information server is determined, according to the analysis results, to be invalid information data, whether standby information data pushed by the target information server is invalid information data is determined. If not, the operation of step S34 is performed; if so, the operation of step S35 is performed.

In step S34, if the standby information data pushed by the target information server is determined to be not invalid information data, information is displayed using the standby information data pushed by the target information server.

In step S35, if the standby information data pushed by the target information server is determined to be invalid information data, information is displayed using valid standby information data pushed by another information server.

In the above steps, if the terminal determines primary information data pushed by an information server as invalid, it may continue to determine whether standby information data pushed by the information server is valid. If valid, information may be displayed with the standby information data; if invalid, information may be displayed with valid standby information data pushed by another information server.

In another way, the standby information data may be invoked by the terminal to display information when the terminal determines the primary information data as invalid information data, which may include the following steps.

Primary information data pushed by a target information server may be analyzed by the terminal, and if the primary information data pushed by the target information server is determined as invalid information data by the terminal according to the analysis results, information may be displayed with valid standby information data pushed by another information server. The target information server is any one of servers that may push information data to the terminal.

In the above ways, when the terminal determines primary information data pushed by an information server to be invalid, it tends to deem that there is a high possibility that the standby information data pushed by the target information server may be also invalid. In this case, the terminal will not analyze the standby information data of the target information server. Instead, valid standby information data pushed by another information server may be used to display information.

In the present disclosure, the information server may be in various forms. For example, the information server may be an advertising server, and then information data may be advertising data. Usually, a terminal is connected to one or more advertising servers. In the solution of the present disclosure, if an advertisement is required to be played, the terminal may send an advertising request to an advertising server. When the advertising request is received, the advertising server may push advertising data including primary advertising data and standby advertising data to the terminal. Upon receiving the advertising data pushed by the advertising server, the terminal may analyze the advertising data. if the primary advertising data thereof is determined to be valid, the terminal may play advertisement corresponding to the primary advertising data; if the primary advertising data is invalid, the terminal may play advertisement corresponding to the standby advertising data. Thus, the problem that a terminal is unable to play advertisement when receiving invalid advertising data can be avoided.

Accordingly, a third embodiment of the present disclosure discloses an electronic device for pushing information, which is applied to information servers. Referring to the structure diagram as shown in FIG. 5, the electronic device for pushing information may include a request receiving module 110 and a data pushing module 120.

The request receiving module 110 may be configured to receive an information request transmitted from a terminal.

The data pushing module 120 may be configured to push information data including primary information data and standby information data to the terminal, so as to allow the terminal to display information with the standby information data when the terminal determines the primary information data as invalid information data.

The information data may usually be address link, such as URL (Uniform Resource Locator) address for the information. Of course, the information data may also be information data in other forms, which are not limited thereto.

The present disclosure discloses an electronic device for pushing information. By the electronic device of the present disclosure, the terminal may display information with standby information data when obtaining invalid information data, which solves the problem in the related art that a terminal is unable to display information when receiving invalid information data.

Further, the information data may be provided with priority tags, and the primary information data has a higher priority than that of the standby information data.

If information data is provided with priority tags, the terminal may analyze priority tag corresponding to each of information data when receiving the information data pushed by the information sever, and determine information data with higher priority as primary information data and information data with lower priority as standby information data, thereby distinguishing primary information data from standby information data with priority tags.

Moreover, the information data may also be arranged in a preset sequence. For example, in the information data pushed by each of information servers, primary information data may be arranged before standby information data. However, an information server may push three primary information data, in which case, a terminal, when receiving the information data pushed by the information sever, may determine the first three information data thereof as primary information data while other information data as standby information data, in such a way that the terminal may distinguish primary information data from standby information data according to the arranged sequence of information data.

As to electronic devices in above embodiments, specific modes in which each module performs its operation have been described in detail in embodiments relevant to the method. Thus detailed description is omitted herein.

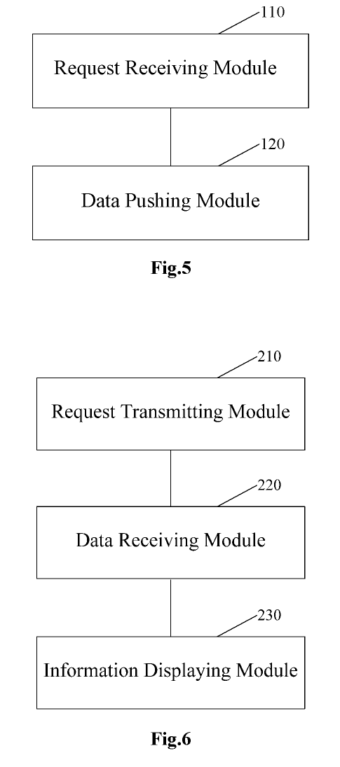

Accordingly, a fourth embodiment of the present disclosure discloses an electronic device for displaying information, which is applied to a terminal. Referring to the structure diagram as shown in FIG. 6, the electronic device for displaying information includes a request transmitting module 210, a data receiving module 220 and an information displaying module 230.

The request transmitting module 210 may be configured to transmit an information request to an information server so as to allow the information server to push information data to a terminal when the information sever receives the information request.

The data receiving module 220 may be configured to receive the information data including primary information data and standby information data pushed by the information server.

The information displaying module 230 may be configured to invoke the standby information data to display information when the primary information data is determined as invalid information data.

The present disclosure discloses an electronic device for displaying information. By the electronic device of the present disclosure, a terminal may display information with standby information data when obtaining invalid information data, which solves the problem in the related art that a terminal is unable to display information when receiving invalid information data.

The information displaying module 230 may be achieved in various forms. In one of the forms, the information displaying module 230 may include: a first displaying unit configured to determine whether standby information data pushed by a target information server is invalid information data when primary information data pushed by the target information server is determined as invalid information data: if not, to display information with the standby information data pushed by the target information server; if so, to display information with valid standby information data pushed by another information server. The target information server may be any one of the servers that may push information data to the terminal.

With the first displaying unit, if the terminal determines primary information data pushed by an information server is invalid, the terminal may continue to determine whether standby information data pushed by the information server is valid. If valid, information is displayed with the standby information data; if invalid, information is displayed with valid standby information data pushed by another information server.

In another form, the information displaying module may include a second displaying unit configured to display information with valid standby information data pushed by another information server when it is determined that primary information data pushed by the target information server is invalid information data. The target information server may be any one of the servers that may push information data to the terminal.

When primary information data pushed by an information server is determined to be invalid, it tends to deem that there is a high possibility that the standby information data pushed by the information server is invalid. In this case, the terminal may display information, with the second displaying unit, according to valid standby information data pushed by another information server.

As to the electronic devices in above embodiments, specific modes in which each of the modules performs its operation have been described in detail in embodiments relevant to the method, and detailed description thereof is omitted herein.

Embodiments of the present disclosure may provide a non-volatile computer storage medium stored with computer executable instructions which are used to perform any of the methods for pushing information in the above method embodiments.

Embodiments of the present disclosure may provide another non-volatile computer storage medium stored with computer executable instructions which are used to perform any of the methods for displaying information in the above method embodiments.

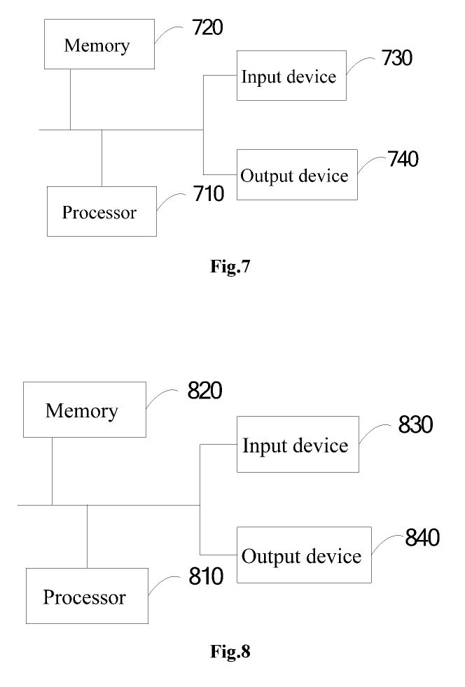

FIG. 7 is a schematic structure diagram of an electronic device for performing a method for pushing information according to an embodiment of the present disclosure. As shown in FIG. 7, the device includes one or more processors 710 and a memory 720, and FIG. 7 illustrates one processor 710 as an example.

The device for performing a method for pushing information may further include an input device 730 and an output device 740.

The processor 710, memory 720, input device 730 and output device 740 may be connected with each other through bus or other forms of connections. FIG. 7 illustrates bus connection as an example.

As a non-volatile computer readable storage medium, the memory 720 may be configured to store non-volatile software program, non-volatile computer executable program and modules, such as program instructions/modules corresponding to the method for pushing information according to the embodiments of the present disclosure (for example, the request receiving module 110 and data pushing module 120, as illustrated in FIG. 5). By executing the non-volatile software program, instructions and modules stored in the memory 720, the processor 710 may perform various functional applications of a server and data processing, that is, the method for pushing information according to the above method embodiments.

The memory 720 may include a program storage area and a data storage area, the program storage area may be stored with an operating system and applications which are needed by at least one functions, and the data storage area may be stored with data which is created according to use of the device for pushing information. Further, the memory 720 may include a high-speed random access memory, and may further include a non-volatile memory, such as at least one of disk memory device, flash memory device or other types of non-volatile solid state memory device. In some embodiments, optionally, the memory 720 may include a memory provided remotely from the processor 710, and such memory may be connected with the device for pushing information through network connections. The examples of the network connections may include but not limited to internet, intranet, LAN (Local Area Network), mobile communication network or combinations thereof.

The input device 730 may receive inputted digital or character information, and generate key signal input related to the user settings and functional control of the device for pushing information. The output device 740 may include a display device such as a display screen.

The above one or more modules may be stored in the memory 720, and when these modules are executed by the one or more processor 710, the method for pushing information according to any one of the above method embodiments may be performed.

FIG. 8 is a schematic structure diagram of an electronic device for performing a method for displaying information according to an embodiment of the present disclosure. As shown in FIG. 8, the device includes one or more processors 810 and a memory 820, and FIG. 8 illustrates one processor 810 as an example.

The device for performing a method for displaying information may further include an input device 830 and an output device 840.

The processor 810, memory 820, input device 830 and output device 840 may be connected with each other through bus or other forms of connections. FIG. 8 illustrates bus connection as an example.

As a non-volatile computer readable storage medium, the memory 820 may be configured to store non-volatile software program, non-volatile computer executable program and modules, such as program instructions/modules corresponding to the method for displaying information according to the embodiments of the present disclosure (for example, the request transmitting module 210, data receiving module 220 and information displaying module 230, as illustrated in FIG. 6). By executing the non-volatile software program, instructions and modules stored in the memory 820, the processor 810 may perform various functional applications of a server and data processing, that is, the method for displaying information according to the above method embodiments.

The memory 820 may include a program storage area and a data storage area, the program storage area may be stored with an operating system and applications which are needed by at least one functions, and the data storage area may be stored with data which is created according to use of the device for displaying information. Further, the memory 820 may include a high-speed random access memory, and may further include a non-volatile memory, such as at least one of disk memory device, flash memory device or other types of non-volatile solid state memory device. In some embodiments, optionally, the memory 820 may include a memory provided remotely from the processor 810, and such memory may be connected with the device for displaying information through network connections. The examples of the network connections may include but not limited to internet, intranet, LAN (Local Area Network), mobile communication network or combinations thereof.

The input device 830 may receive inputted digital or character information, and generate key signal input related to the user settings and functional control of the device for displaying information. The output device 840 may include a display device such as a display screen.

The above one or more modules may be stored in the memory 820, and when these modules are executed by the one or more processor 810, the method for displaying information according to any one of the above method embodiments may be performed.

The electronic device in embodiments of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for displaying information, comprising:
transmitting, by a terminal, an information request to an information server, so as to allow the information server to push information data to the terminal when the information server receives the information request;
receiving, by the terminal, the information data pushed by the information server, the information data comprising primary information data and standby information data; and
invoking, by the terminal, the standby information data to display information when the terminal determines the primary information data as invalid information data.

2. The method according to claim 1, wherein, the invoking, by the terminal, the standby information data to display information when the terminal determines the primary information data as invalid information data comprises:
determining, by the terminal, whether the standby information data pushed by a target information server is invalid information data when the terminal determines primary information data pushed by the target information server as invalid information data: if the standby information data pushed by a target information server is not invalid information, displaying information with the standby information data pushed by the target information server; if the standby information data pushed by a target information server is invalid information, displaying information with valid standby information data pushed by another information server, wherein, the target information server is any one of servers that pushes information data to the terminal.

3. The method according to claim 1, wherein, the invoking, by the terminal, the standby information data to display information when the terminal determines the primary information data as invalid information data comprises:
displaying, by the terminal, information with valid standby information data pushed by another information server when the terminal determines primary information data pushed by a target information server as invalid information data, wherein, the target information server is any one of servers that pushes information data to the terminal.

4. A non-volatile computer-readable storage medium, which is stored with computer executable instructions that, when executed by an electronic device, cause the electronic device to:
transmit, by a terminal, an information request to an information server, so as to allow the information server to push information data to the terminal when the information server receives the information request;
receive, by the terminal, the information data pushed by the information server, the information data comprising primary information data and standby information data; and
invoke, by the terminal, the standby information data to display information when the terminal determines the primary information data as invalid information data.

5. The non-volatile computer-readable storage medium according to claim 4, wherein, the step to invoke, by the terminal, the standby information data to display information when the terminal determines the primary information data as invalid information data comprises:
determining, by the terminal, whether the standby information data pushed by a target information server is invalid information data when the terminal determines primary information data pushed by the target information server as invalid information data: if the standby information data pushed by a target information server is not invalid information data, displaying information with the standby information data pushed by the target information server; if the standby information data pushed by a target information server is invalid information data, displaying information with valid standby information data pushed by another information server, wherein, the target information server is any one of servers that pushes information data to the terminal.

6. The non-volatile computer-readable storage medium according to claim 4, wherein, the step to invoke, by the terminal, the standby information data to display information when the terminal determines the primary information data as invalid information data comprises:
displaying, by the terminal, information with valid standby information data pushed by another information server when the terminal determines primary information data pushed by a target information server as invalid information data, wherein, the target information server is any one of servers that pushes information data to the terminal.

7. An electronic device, comprising:
at least one processor; and
a memory, communicably connected with the at least one processor and storing instructions executable by the at least one processor,
wherein execution of the instructions by the at least one processor causes the at least one processor to:
transmit, by a terminal, an information request to an information server, so as to allow the information server to push information data to the terminal when the information server receives the information request;
receive, by the terminal, the information data pushed by the information server, the information data comprising primary information data and standby information data; and
invoke, by the terminal, the standby information data to display information when the terminal determines the primary information data as invalid information data.

8. The electronic device according to claim 7, wherein, the step to invoke, by the terminal, the standby information data to display information when the terminal determines the primary information data as invalid information data comprises:
determining, by the terminal, whether standby information data pushed by a target information server is invalid information data when the terminal determines primary information data pushed by the target information server as invalid information data: if standby information data pushed by a target information server is not invalid information data, displaying information with the standby information data pushed by the target information server; if standby information data pushed by a target information server is invalid information data, displaying information with valid standby information data pushed by another information server, wherein, the target information server is any one of servers that pushes information data to the terminal.

9. The electronic device according to claim 7, wherein, the step to invoke, by the terminal, the standby information data to display information when the terminal determines the primary information data as invalid information data comprises:
displaying, by the terminal, information with valid standby information data pushed by another information server when the terminal determines primary information data pushed by a target information server as invalid information data, wherein, the target information server is any one of servers that pushes information data to the terminal.
